(19) United States
(12) Patent Application Publication
(10) Pub. No.: US 2016/0104103 A1
(43) Pub. Date: Apr. 14, 2016

(54) GAS CYLINDER COUNTING SYSTEM

(71) Applicant: RATERMANN MANUFACTURING, INC., Livermore, CA (US)

(72) Inventor: George W. Ratermann, Livermore, CA (US)

(73) Assignee: RATERMANN MANUFACTURING, INC., Livermore, CA (US)

(21) Appl. No.: 14/799,230

(22) Filed: Jul. 14, 2015

Related U.S. Application Data
(63) Continuation-in-part of application No. 14/509,532, filed on Oct. 8, 2014.
Application No. 14/509,532 is a continuation-in-part of application No. 14/509,570, filed on Oct. 8, 2014.

(51) Int. Cl. G06Q 10/08; G01D 5/48; G01D 5/26

(52) U.S. Cl. CPC G06Q 10/087; G01D 5/26; G01D 5/48

(57) ABSTRACT

A gas cylinder counting apparatus that has bins with aligned parallel rows of industrial gas cylinders stored in a cage having upright posts with gas cylinder movement detectors. Gas cylinders in each bin are separated from each other to form a cylinder array. Proximity sensors attached to posts count cylinder removals by changes of state of the cylinder array and report removal of a cylinder from the bin to a local server. When gas cylinders are removed from other cages, local servers report to a remote server and to the management software for gas cylinder ordering and delivery.

### CROSS-REFERENCE TO RELATED APPLICATION

This application is a continuation-in-part of prior applications Ser. No. 14/509,532, filed Oct. 8, 2014 and Ser. No. 14/509,570, filed Oct. 8, 2014.

### TECHNICAL FIELD

The invention relates to a gas cylinder inventory signaling from a storage cage in a gas cylinder system.

### BACKGROUND ART

Industrial concerns, such as hospitals, welding shops, chemical processing plants and similar businesses, use large numbers of cylinders of industrial gases. Cylinders are delivered to such businesses in full condition and picked up after use. The cylinders are heavy, expensive and must be carefully stored. Methods for distribution and inventory control have been a subject of much research for many years. For example, see the paper in

Interfaces 13, 6 Dec. 1983, p. 4-23 entitled “Improving the Distribution of Industrial Gases with an On-Line Computerized Routing and Scheduling Optimizer” by W. J. Bell et al. The article describes the efforts of Air Products and Chemicals, Inc. to implement industrial gas cylinder inventory management at customer locations with delivery vehicle scheduling. A sophisticated software algorithm for the project is described. An essential part of the gas cylinder management problem is knowing the present inventory of full and empty tanks. Usually a customer is responsible for inventory status and different customers have different approaches.

### SUMMARY DISCLOSURE

One of the inputs for gas cylinder management software for industrial gas cylinders comes from a tank farm where gas cylinders are stored prior to use. The present invention contemplates a gas cylinder cage that has multiple rows where gas cylinders are stored, the cage having upright posts and horizontal rails aligning multiple cylinders in rows called bins, sometimes with a safety closure such as a cable between members of a row that establish a geometric array. The upright posts support proximity sensors which report removal of a cylinder to a local server that maintains a count of cylinders in the cage. The sensors are associated with array logic having a first logic state indicating a quiet state associated with a known number of cylinders and a second logic state indicating removal of a cylinder from a bin. Multiple proximity sensors communicate with a networked local server for signaling changes of logic states associated with removal of cylinders from different bins. Upon removal of a gas cylinder from a bin, proximity sensors sense each removal as a change in the geometric storage pattern of the cylinders. This change is a change of state of the pattern from an initial array to a state with one less gas cylinder. Logic devices counting such removals report to a local server. A plurality of local servers having such changes is connected via the Internet or otherwise to a remote server that is associated with gas cylinder management and supply software and route management software. The remote server tracks cylinder usage from the cylinder tank storage units and orders replacement tanks and optimizes delivery of replacement cylinders. The remote server can display gas cylinder management information via a website or a smart phone app.

### BRIEF DESCRIPTION OF THE DRAWINGS

FIG. 1 is a perspective plan view of a gas cylinder cage in accordance with the invention.

FIG. 2 is a top plan view of a gas cylinder array having three parallel bins with upright industrial gas cylinders.

FIGS. 3a-3c are front views of one row of a gas cylinder cage with a gas cylinder.

FIG. 4 is an electrical plan of a gas cylinder inventory signaling system in accordance with the invention.

### DETAILED DESCRIPTION

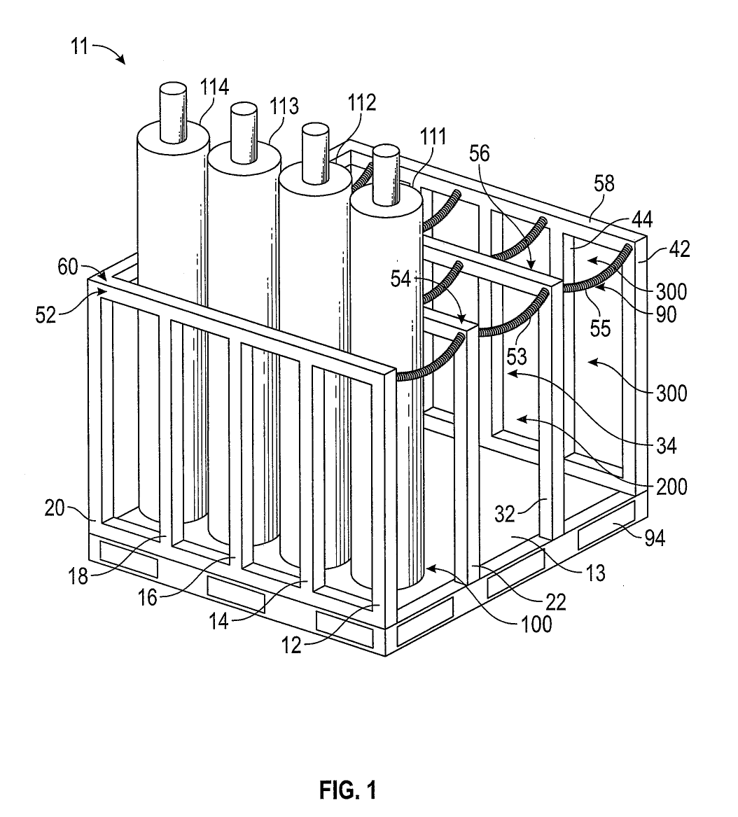

With reference to FIG. 1, a gas cylinder cage 11 is shown having a plurality of bins 100, 200, and 300. The gas cylinder cage 11 has a floor 13 and upright posts 12, 14, 16, 18, 20, 22, 32, 34, 42, 44, etc. that support parallel rails or fences 52, 54, 56, 58, with spaced apart pairs of rails forming each tank storage bin to establish a geometric array of gas cylinders. The rails also form the side walls and back wall 60 of the cage, with the front, opposite to back wall 60, being open for placement and removal of gas cylinders into and out of the cage. FIG. 1 shows three bins 100, 200 and 300. The width of each bin, such as bin 100, exceeds the width of a gas cylinder such as gas cylinders 111, 112, 113, and 114 by a slight amount, an inch or two on a side, such that a series of cylinders may be aligned in a bin, as shown in bin 100. The width of a bin will accommodate only one gas cylinder but the depth of a bin will accommodate several cylinders. The height of the upright posts is sufficient so that the gas cylinders cannot tip over or be readily lifted over the posts but must be removed from the front of the cage.

Each bin, such as bin 100, has an optional series of cables securing tanks in specified spaced apart positions. The cables may be chains, such as chains 90, that may be connected onto the posts 12, 22, and 32 to form gas cylinder enclosures that establish an array of cylinders, such as a rectangular x-y array. Other cables may be uniformly spaced in a bin and sets of cables may be connected between posts to secure the cylinders in an upright position particularly where seismic safety is an issue. Cables are coupled by clasps to posts 22, 32, and 42, and are manually releasable to allow adding and removing of gas cylinders in and out of a bin.

When gas cylinders are placed in the bins, all of the cables are manually released to accommodate entry of the cylinders into the bins. Then, as each cylinder is placed in a bin, toward the back of the bin insofar as possible, the cables are hooked up to the posts manually to allow each gas cylinder to be enclosed in a designated space so that a tank array geometry is established. The array geometry becomes an initial logic state at a local server. If cables are not used, other tank location means can be used, such as visual placement. When all bins are full of tanks, the cage typically has a rectangular array of gas cylinders in rows and columns whether cables are used or not. A maximum number of gas cylinders is typically placed in a cage since a rectangular floor footprint can accommodate a certain size. For example, a floor size can correspond to dimensions for being set on a shipping palette size of 34 inches by 42 inches, or a few inches smaller or larger on each side. The bin cage 11 may have a steel or aluminum floor with square cut outs 94 for a fork lift driver to lift the bin cage 11 onto a palette or transfer the bin cage 11 directly.

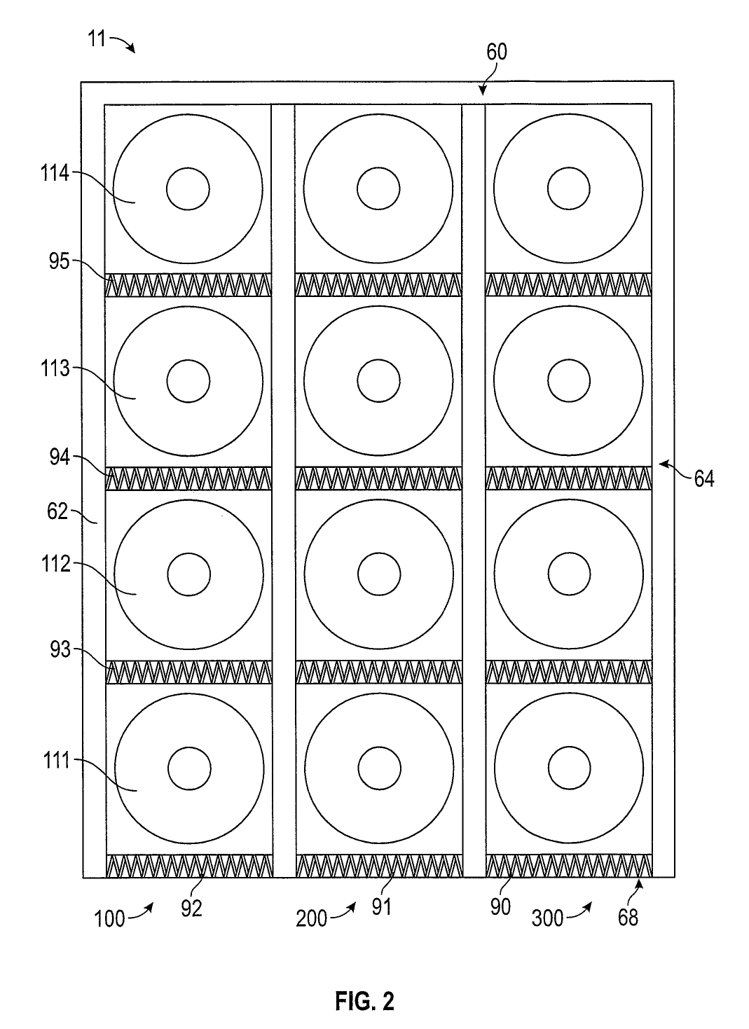

With reference to FIG. 2, the cylinder cage 11 is shown to have opposite side walls 62 and 64, with back wall 60. The front 68 of the tank cage is open when cables 90, 91, and 92 are open, but appears closed when the cables are latched to the posts. A first row of gas cylinders 111, 112, 113, and 114 are shown to be aligned in the first bin 100 as part of a grid pattern established by closure of respective cables 92, 93, 94, and 95. The closed cable associated with each gas cylinder is at the front of each cylinder with the front direction being associated with the front 68 of the cage 11. As previously mentioned use of cables is optional and merely establishes a geometric cylinder pattern for counting purposes. Other cylinder placement mechanisms can be used so long as a grid pattern of cylinders is established. Unlatching of a forward cable can be used to signal removal of a cylinder from a bin. Full bins 100, 200, 300 establish a full cage as an initial logic state with 12 cylinders.

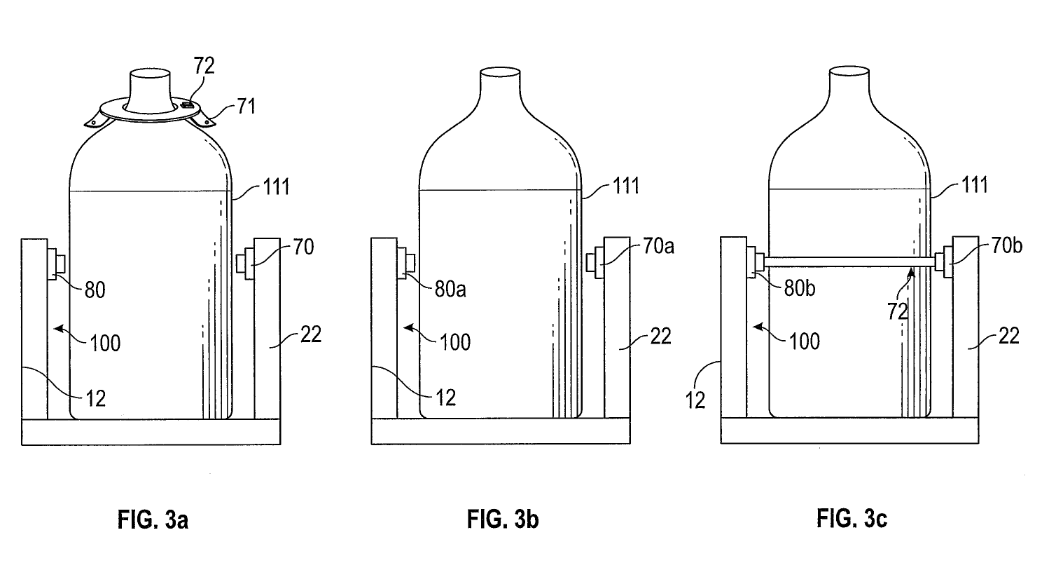

With reference to FIG. 3a, the open end of a single bin 100 of a tank cage is shown. No cables are used because gas cylinders are situated visually. Bin 100 is shown to have a gas cylinder 111 with a collar 71. In one embodiment, proximity sensors 70 and 80 are RFID detectors. On the cylinder 111 the collar 71 has an RFID chip 72. When a gas cylinder is removed from the bin, the RFID detectors 70 and 80 which are mounted to posts 12 and 22 of the bin cage both detect the removal of the gas cylinder from the cage as it passes the bin cage posts 12 and 22. The almost equal proximity to RFID sensors 70 and 80 to RFID chip 72 presents a balanced signal to the detectors that does not occur when a cylinder from a neighboring bin is removed and sensed by the same detectors. In that situation sensors 70 and 80 detect an unbalanced signal. The RFID sensors indicate to a server located nearby the cage that a gas cylinder 111 has been removed.

In FIG. 3b showing another embodiment of the proximity sensor, ultrasonic sensors 70a and 80a may be mounted to posts 12 and 22 of the bin cage rather than RFID detectors. When a gas cylinder 111 passes the bin cage posts 12 and 22, ultrasonic waves detect the removal of gas cylinder 111 and an indicator can send a signal to a server located nearby the bin cage to indicate that a gas cylinder 111 has been removed.

In another embodiment of a proximity sensor, shown in FIG. 3c, an optical light beam 72 may be established between bin cage posts 12 and 22 having a light beam source 70b and a detector 80b. When a gas cylinder 111 is removed from a bin cage, the gas cylinder passes through the light beam 72. When the light beam 72 is broken as a gas cylinder passes through the beam, a signal from the optical light beam detector 80b is sent to the server located nearby to indicate that a gas cylinder 111 has been removed.

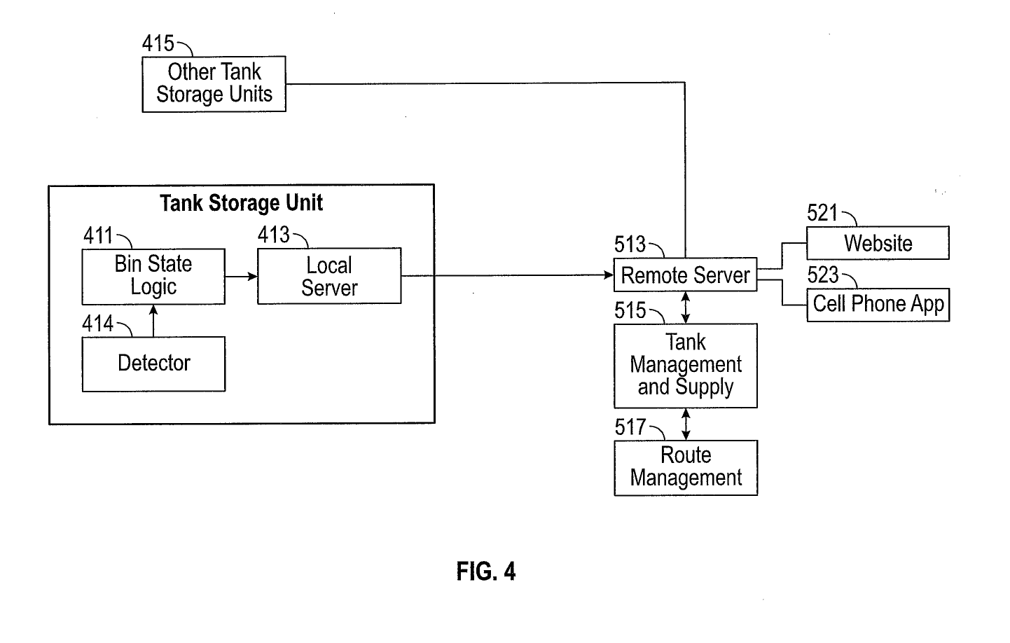

A user sets the initial state of a tank cage, i.e. an initial count of tanks in bins of the cage, in state logic 411, seen in FIG. 4. Logic 411 consists of memory FPGA's that monitor changes or decrements from the initial state of the cylinder array to the next state, and so on. When a cylinder is removed, detector 414 signals a state change to logic 411 as a count monitored in local server 413. In other words the geometric pattern of cylinders in the bin is a state. Each change of state is counted and interpreted as a removal of a gas cylinder from the bin. The kinds of gas in each bin are also tracked in logic 411.

A light beam in FIG. 3c, an RFID sensor in FIG. 3a, or ultrasonic sensor in FIG. 3b can detect tank removal indicating a change in the state of a bin array that is reported to the local server 413. Local reporting may be by a local wire network or a wireless network. The local server 413 reports the bin array indicator state to a remote server 513 via the Internet or a private line. The remote server 513 tracks similar information from other tank storage units 415.

Remote server 513 has a count of cylinders removed from bins based upon the bin array sensor states from all connected cylinder storage units reporting through local servers. The count may be a database associated with different types of industrial gases where each bin is associated with a specific gas. The logic monitors each bin and its associated specific gas. Such a database is used by known tank management and supply software 515 that handles ordering, purchasing, stocking, and location of replacement cylinders. In turn, the tank management supply module 515 is connected to a route management module 517 that optimizes delivery of replacement cylinders. Both tank and cylinder management and supply software and route management software are well known and have been described in many publications.

The remote server 513 has a video display output that can be an internet website 521 or a cell phone app 523 so that the server database can be graphically shown to users. Cylinder management supply software 515 and route management software 517 also communicate with the remote server for display of information through the website and the cell phone app.

In operation, if there has been no change in the initial bin array indicator state from a gas cylinder storage unit, no cylinders have passed through the proximity sensor, no replacement cylinders or tanks are needed for that location and such information can be displayed on a website or a cell phone app. On the other hand, if cylinder detectors show that two gas cylinders have passed out of a bin in a tank cage, it is assumed that two replacement cylinders of the type stored in that bin are now needed. This information is conveyed by a local server to a remote server and then to the website or cell phone app. Replacement gas cylinder procurement is handled by the cylinder or tank management and supply software 515 and delivery is handled by the route management software 517. All of this is facilitated by the cylinder cage of the present invention with bins holding gas cylinder tanks behind proximity sensors mounted to posts of the bin cage which communicate with proximity sensor logic as described.

What is claimed is:

1. A gas cylinder counting system comprising:
a cage having a plurality of parallel gas cylinder bins having a width accommodating only one gas cylinder and a depth accommodating several gas cylinders;
a gas cylinder sensor associated with each bin detecting removal of a cylinder from a bin;
a logic device communicating with all sensors having a first logic state signaling a cage state prior to removal of cylinders and other logic states signaling removal of cylinders from bins of the cage.

2. The apparatus of claim 1 comprising a local server in communication with the gas cylinder sensor for receiving logic state signals of the sensors associated with counted removal of the gas cylinders from the cage.

3. The apparatus of claim 2 comprising a remote server in communication with the local server having gas cylinder management software whereby gas cylinder removal counts reported by local servers are aggregated in management software for gas cylinder ordering and delivery.

4. The apparatus of claim 1 wherein the cage has a floor with upwardly extending posts and horizontal rails forming said bins.

5. The apparatus of claim 1 wherein said proximity sensor is an RFID sensor.

6. The apparatus of claim 1 wherein said proximity sensor is an ultrasonic sensor.

7. The apparatus of claim 1 wherein said proximity sensor is a light beam sensor.

8. The apparatus of claim 1 wherein cables separate gas cylinders in each bin.

9. The apparatus of claim 8 wherein a cable closes the front of each bin.

10. The apparatus of claim 1 wherein the number of bins is 3.

11. A gas cylinder counting system comprising:
a cage having a floor with upright posts joined on by a plurality of horizontal side rails, with some of the posts and side rails spaced apart by a distance slightly greater than the diameter of a tank, with adjacent pairs of parallel side rails defining a gas cylinder bin, the floor having sufficient posts and rails for at least two gas cylinder bins with each bin having an openable front and a back closed by a back rail; and
a gas cylinder sensor attached to at least one post and associated with a logic device having a first logic state signaling a first state relating to gas cylinders in the cage and a second logic state different from the first logic state signaling removal of a gas cylinder from the bin of the cage.

12. The apparatus of claim 11 comprising a local server in communication with the gas cylinder sensor for receiving logic state signals of the sensors associated with counted removal of the gas cylinders from the cage.

13. The apparatus of claim 12 comprising a remote server in communication with the local server having gas cylinder management software whereby gas cylinder removal counts reported by local servers are aggregated in management software for gas cylinder ordering and delivery.

14. The apparatus of claim 11 wherein the rectangular floor is approximately pallet size.

15. The apparatus of claim 11 wherein said proximity sensor is an RFID sensor.

16. The apparatus of claim 11 wherein said proximity sensor is an ultrasonic sensor.

17. The apparatus of claim 11 wherein said proximity sensor is a light beam sensor.

18. The apparatus of claim 11 wherein cables separate gas cylinders in each bin.

19. The apparatus of claim 18 wherein a cable closes the front of each bin.

20. The apparatus of claim 11 wherein the number of bins is 3.
